(19) United States
(12) Patent Application Publication
(10) Pub. No.: US 2026/0265043 A1
(43) Pub. Date: Sep. 10, 2026

(54) IN-LINE FUEL DELIVERY FILTER AND METHOD OF PROVIDING FUEL USING THE IN-LINE FUEL DELIVERY FILTER

(71) Applicant: Derek Morris, Hurst, TX (US)

(72) Inventor: Derek Morris, Hurst, TX (US)

(21) Appl. No.: 19/075,269

(22) Filed: Mar. 10, 2025

(51) Int. Cl. B67D 7/04

(52) U.S. Cl. CPC B67D 7/04; B67D 2210/0001; B67D 2210/00062

(57) ABSTRACT

The disclosure provides an in-line fuel delivery filter (referred to herein as an IFD filter) that eliminates or at least reduces the amount of contaminants in the fuel that is delivered to bulk fuel tanks. In one aspect, the disclosure provides an IFD filter for use with a fuel delivery hose having a female portion of a connector at one end. In one example, the IFD filter includes (1) a filter bag and (2) a coupling ring connected to the filter bag, wherein the filter bag is affixed to the coupling ring and the coupling ring is configured to rest on a circular protrusion of the female portion of the connector. The bulk fuel tanks can be Above Ground Storage tanks or Underground Storage Tanks.

### CROSS-REFERENCE TO RELATED APPLICATION

This application claims the benefit of U.S. Provisional Application Ser. No. 63/563,140, filed by Derek Morris, on Mar. 8, 2024, entitled “IN-LINE FUEL DELIVERY FILTER AND METHOD OF PROVIDING FUEL USING THE IN-LINE FUEL DELIVERY FILTER”, which is commonly assigned with this application and incorporated herein by reference in its entirety.

### TECHNICAL FIELD

This application is directed, in general, to the delivery of fuel and, more specifically, to filtering the fuel during delivery to a bulk fuel tank.

### BACKGROUND

Fuel delivery vehicles are typically used to transport fuel from a fuel terminal to an end user's bulk fuel storage tank, or simply bulk fuel tank. Upon arrival, a fuel truck operator connects a hose from a valve mounted on the fuel delivery vehicle to a fill pipe connection or valve mounted on the bulk fuel tank. The valves on the fuel delivery vehicle and bulk fuel tank can be permanently mounted valves. The hoses include a camlock connection on each end that provides a sealed connection between the hose and the valves for the fuel delivery. One end of the hose typically has a “female” coupler connection, and the other end of the hose has a “male” adaptor connection. The size of the hose can vary and can be, for example a 2″, 3″, or a 4″ hose.

Bulk fuel tanks can be installed above the ground level, or below the ground level. A tank installed above the ground level is known as an Above Ground Storage Tank or simply AST. During a fuel delivery, fuel is pumped into an AST from the fuel delivery vehicle. A tank installed below the ground level is known as an Underground Storage Tank or simply UST. Since USTs are underground, the fuel is gravity fed into the tank due to environmental regulations. For example, pumping the fuel may result in over pressuring the UST, which can cause cracks and allow the fuel to leak into the ground. As such, a fuel truck operator connects a hose from the valve on fuel delivery vehicle directly to the UST valve and allows the fuel to gravity feed into the UST.

### SUMMARY

In one aspect, the disclosure provides an in-line fuel delivery (IFD) filter for use with a fuel delivery hose having a female portion of a connector at one end. In one example, the IFD filter includes (1) a filter bag and (2) a coupling ring connected to the filter bag, wherein the filter bag is affixed to the coupling ring and the coupling ring is configured to rest on a circular protrusion of the female portion of the connector.

In another aspect, the disclosure provides a fuel delivery system. In one example, the fuel delivery system includes: (1) a fuel delivery hose and (2) an IFD filter located within a female camlock coupler of the fuel delivery hose, wherein the IFD filter includes a filter bag and a coupling ring connected to the filter bag, wherein the filter bag is affixed to the coupling ring and the coupling ring is configured to rest on a circular protrusion of the female camlock coupler.

In yet another aspect, the disclosure provides a method of delivering fuel to a bulk fuel tank. In one example, the method includes: (1) placing an IFD filter into a female camlock coupler of a fuel delivery hose, wherein the IFD filter includes a filter bag and a coupling ring connected to the filter bag, wherein the filter bag is affixed to the coupling ring and the coupling ring is configured to rest on a circular protrusion of the female camlock coupler, and (2) connecting the female camlock coupler to a male camlock adaptor integrated with a valve of a fluid delivery vehicle.

### BRIEF DESCRIPTION OF THE DRAWINGS

Reference is now made to the following descriptions taken in conjunction with the accompanying drawings, in which:

FIG. 1 illustrates a diagram of an example of a fuel delivery process carried out according to the principles of the disclosure;

FIGS. 2A-2D illustrate different viewpoints of an example of an IFD filter constructed according to the principles of the disclosure;

FIGS. 3A-3C illustrate different viewpoints and features of coupling ring constructed according to the principles of the disclosure;

FIG. 4 shows a portion of the fuel delivery system of FIG. 1 with an IFD filter being placed in the female coupler of the fuel delivery hose;

FIG. 5 shows a top view of the fuel delivery system of FIG. 1 after the IFD filter is placed in the female coupler of the fuel delivery hose;

FIG. 6 represents a connection between the female coupler and a male adapter, such as integrated with the valve of the fuel delivery vehicle in FIG. 1; and

FIG. 7 illustrates a flow diagram of an example method of delivering fuel carried out according to the principles of the disclosure.

### DETAILED DESCRIPTION

The American Society for Testing and Materials (ASTM) International Standard D975 outlines the specific allowable chemical properties and cleanliness for various grades of diesel fuel. Within this standard, the cleanliness for #2 Ultra Low Sulfur Diesel (ULSD) allows 0.05% of water and sediment by volume in each delivery, this equates to about 500 PPM. In a tanker load of 7,500 gallons of diesel, 500 PPM of water and sediment equals about 1.5 pounds of dirt and about 1 gallon of water blended into the volume of fuel. As such, the amount of water and sediment consistently increases inside a bulk fuel tank after each fuel delivery that eventually results in a costly service to remove the build-up of contamination to clean the bulk fuel tank.

For modern diesel fuel engines, the fuel is recommended to contain less than 100 PPM of water and sediment for the engines to properly perform and maintain efficiency. For example, 120 PPM of water or a teaspoon of sediment in a volume of fuel being directly supplied to an engine can damage the engine. As such, diesel engine manufacturers typically specify a required cleanliness level of diesel fuel in order to maintain new engine warranty, maximize life expectancy, and maximize efficiency. The International Organization for Standardization (ISO) has established a method of quantifying contaminant levels within petroleum fluids including diesel fuel. Based on this method, most engine manufacturers specify that diesel fuel with an ISO cleanliness code of 12/9/6 is optimal for fuel that is being delivered into the onboard fuel tank of the truck or equipment.

Several filter manufacturers have designed fuel filtration systems specifically to be installed on the inlet of a bulk fuel tank. These existing filter systems are designed to operate under a positive pressure, or with fuel being pumped through it. Additionally, these filter systems are permanently affixed to the bulk fuel tank and require a large amount of space in the tank area when installed.

The existing fuel filtration systems, therefore, are not applicable for USTs since USTs are gravity filled. Additionally, USTs are typically placed in the middle of a parking lot or driveway where consumer traffic drives over the top of covers designed to protect the fill pipe connections, fluid level sensors, and the fuel pump which are attached to the tank under the ground level. As such, adding a permanent filter system for fuel delivery is not practical due to, for example, vehicle traffic. Furthermore, the existing permanent fuel filtration systems can cost tens of thousands of dollars.

Regardless an AST or a UST, the fuel stored in the bulk fuel tanks should remain relatively clean to minimize the amount of contamination pumped into the onboard fuel tank of the truck or equipment being used. Each time a fuel pumping system or fuel dispenser system is activated, the volume of fuel being pumped out of a bulk fuel tank will carry a percent of the contamination out of the bulk fuel tank, through the fuel piping and hoses, into the next storage container. The amount of contamination that is pumped out of a bulk fuel tank into the next storage container is proportionate to the pre-existing level of contamination within the bulk fuel tank. A higher level of contamination in the bulk fuel tank equals a higher level of contamination being pumped out. A lower level of contamination in the bulk fuel tank equals a lower level of contamination being pumped out. Filtration is needed to reduce the amount of contamination carried out of the bulk fuel tank with the fuel. Most fuel delivery companies, however, do not add filtration into their fuel delivery systems due to the initial investment costs and rigorous ongoing maintenance (e.g., filter replacement). Additionally, the amount of space required can be probable.

The disclosure provides an in-line fuel delivery filter (referred to herein as an IFD filter) that eliminates or at least greatly reduces the amount of contaminants in the fuel that is delivered to bulk fuel tanks. The IFD filter includes a filter element, also referred to herein as filter bag, and a filter head, also referred to herein as a coupling ring. The filtration capability of the IFD filter can vary depending on the selected type of filter material that is used for the filter bag. For example, the amount of contaminants captured by the IFD filter can relate to the micron rating or grade of the material used for the filter bag. The micron rating can be selected based on a balance between a desired fuel delivery flow rate and contaminant capture capability.

The IFD filter can be used with both ASTs and USTs. Accordingly, the IFD filter can be used for both pumped and gravity type of fuel deliveries, which prevents requiring different filters for the different types of fuel deliveries. The IFD filters can be used with different types of liquid fuels, also. For example, the IFD filter can be used with different types of diesel and gasoline, such as biodiesel, aviation fuel, unleaded gasoline, different grades of gasoline, etc. As such, the material used for the filter bag is suitable for use with different types of fuel. In some instances, a specific type of material may be used for a specific type of fuel that is being delivered.

As suggested by its name, the IFD filter advantageously fits within a fuel delivery hose. The IFD filter, for example, is designed to fit within the female coupler of a connector used to securely connect the fuel delivery hose to a fuel delivery truck. The fuel delivery hose can be connected to a valve of the fuel delivery vehicle that has a male adaptor that corresponds to the female coupler. The connector can be a camlock connector. The connection can be secured when a leak-proof connection is made. For example, when the female coupler is aligned around the male adaptor and cam levers of the female coupler are closed. The IFD filter can be in different sizes that correspond to different sizes of fuel delivery hoses. For example, 2″, 3″, 4″ hoses, or greater as needed.

The coupling ring is specifically designed to be compatible with the camlock connections used during a fuel delivery. As such, each of the disclosed coupling rings have a circumference, diameter, thickness, and width for one of the specific sizes of the camlock connections that correspond to the different hose sizes used in the fuel delivery. The coupling rings are also constructed of a material that is compatible with the fuel being pumped therethrough.

The coupling rings are designed to fit in a groove within a pre-existing camlock connection and is designed to perform at least two functions. The first function is to create a seal between a male and female camlock connection when the male and female are connected together. The second function is to provide an extended surface (referred to as a flange extension or simply flange) to allow attachment, such as via stitching or heat welding, of a filter bag onto the coupling ring. The IFD filter can only include the filter bag attached to the coupling ring. The filter bag and the coupling ring of the IFD can be permanently connected via various means, such as a mechanical, chemical, or combination thereof. Various types of welding can be used for the connection. Stitching and stapling are other possible examples. A glue or epoxy may also be used. In some examples, the filter bag can be non-permanently attached to the coupling ring. As such, the coupling ring can be reused for more than one fuel delivery. One or more circular clamps, for example, can be used to non-permanently attach the filter bag to the coupling ring. For example, a circular wedge can be internally aligned with the flange and a circular clamp can be secured around the filter bag and the external side of the flange. The circular wedge can include an arm or spoke within the diameter that can be used to place the circular wedge and hold the circular wedge when tightening the circular clamp. The spoke can also be used to remove the IFD filter after use. As such, a tab as noted below may not be needed in some examples. In some examples, the flange may be sufficiently rigid wherein the circular wedge may not be needed.

The materials used for the coupling ring and the filter bag can be a commercially available materials that are fuel tolerant materials that can withstand exposure to the various fuels without loss of function and structural integrity. The coupling ring, for example, can be constructed of a polyurethane, such as polyether thermoplastic polyurethane, and the filter bags can be constructed of synthetic fibers.

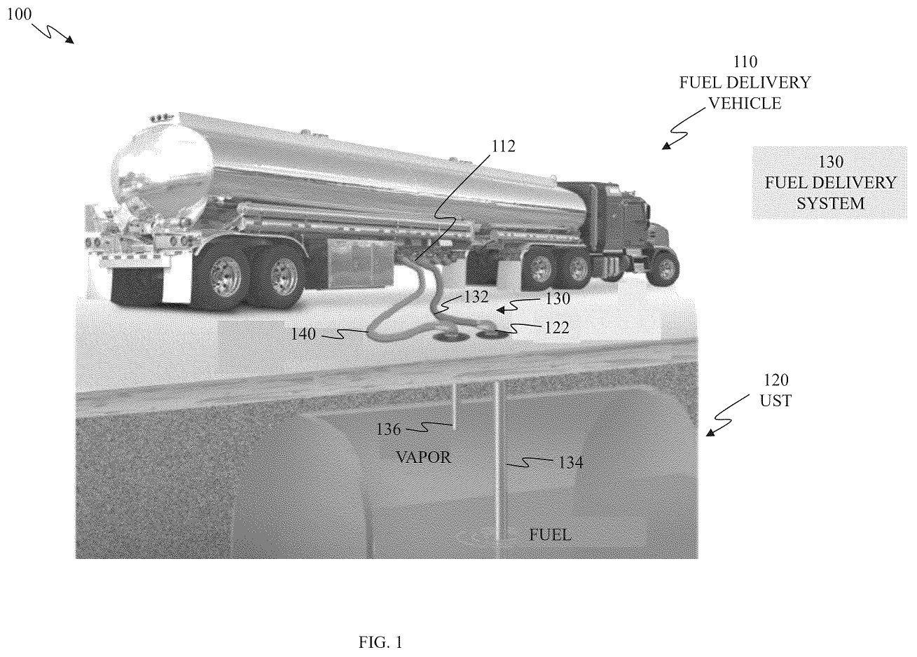

FIG. 1 illustrates a diagram of an example of a fuel delivery process 100 carried according to the principles of the disclosure. The fuel delivery process 100 is an example of a closed off-loading system from a fuel delivery vehicle 110 to a UST 120. The fuel delivery vehicle 110 can also be referred to as a fuel truck, a tank truck, a gas truck, or another type of vehicle designed to transport and deliver large quantities of fuel. The fuel delivery vehicle 110 includes a fuel trailer but other types of fuel delivery vehicles can also be used.

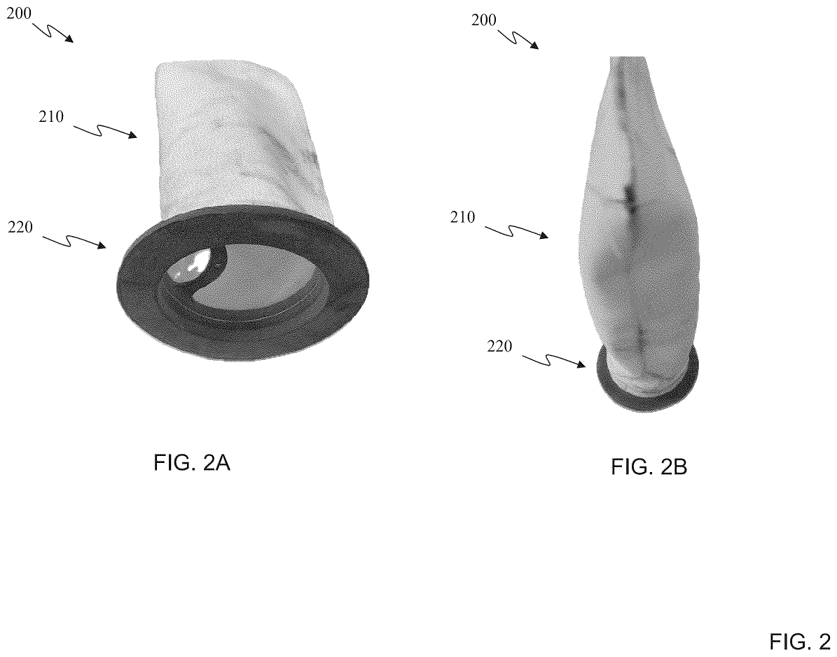

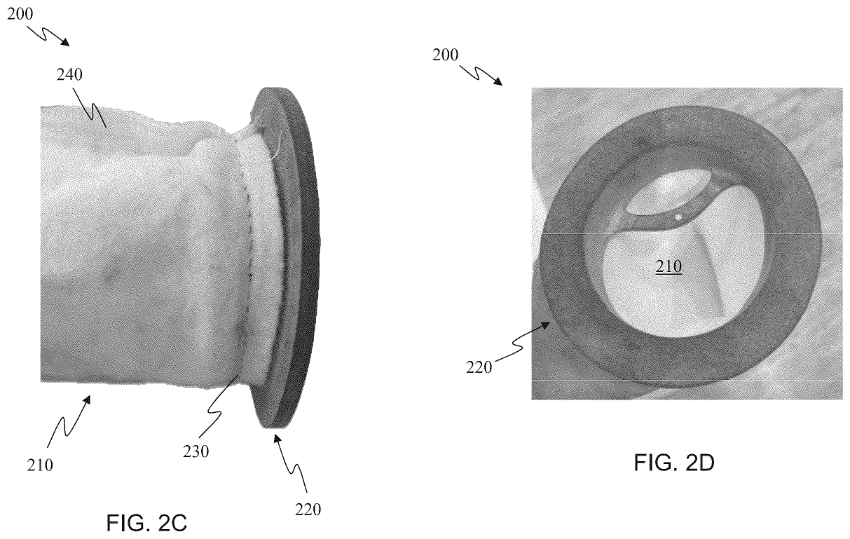

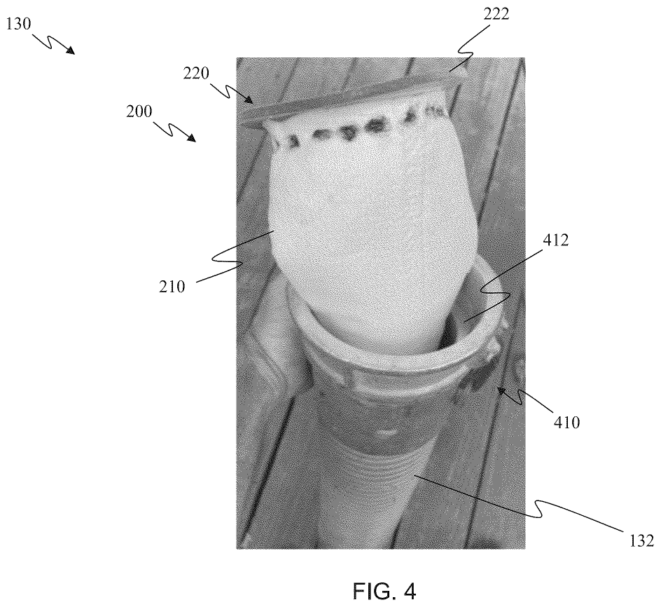

The fuel delivery vehicle 110 is shown delivering fuel to the UST 120 via a fuel delivery system 130. The fuel delivery system 130 includes a hose 132 that is connected to a valve 112 of the fuel delivery vehicle 110 and valve 122 associated with the UST 120. The hose 132 can be connected to the valves 112, 122, via camlocks. Valve 112 can have a male adaptor and valve 122 can have a female coupler. When the valves 112, 122, are open, fuel is gravity-fed from the fuel delivery vehicle 110 to the UST 120 via the hose 132 and a delivery pipe 134. The fuel also passes through an IFD filter (not visible in FIG. 1) of the fuel delivery system 130 when being fed into the UST 120. The IFD filter is located within a female portion of a camlock connector used to securely connect the hose 132 to a male camlock connector of the valve 112. The IFD filter can be, for example, IFD filter 200 of FIGS. 2A-2D. FIGS. 4 to 6 illustrates examples of IFD filter 200 being placed in a female coupler 410 of hose 132 and an example of a male adaptor 610 that can be integrated with valve 112. The size of the hose 132 can vary as noted above.

Another hose 140 is shown in FIG. 1 that is used for vapor recovery. Hose 140 is also connected to the fuel delivery vehicle 110 and the UST 120 via valves (not designated in FIG. 1). A recovery pipe 136 is also shown that is connected to hose 140. The hose 140 and recovery pipe 136 can be conventional features typically used in a fuel delivery process for a UST.

FIGS. 2A-2D illustrate different viewpoints of an example of an IFD filter 200 constructed according to the principles of the disclosure. The IFD filter 200 includes a filter bag 210 and a coupling ring 220. FIG. 2A shows a front-angle view of the IFD filter 200 showing the face of the coupling ring 220 and the filter bag 210 extending from the coupling ring 220.

FIG. 2B shows a top-angle view of the IFD filter 200 with the filter bag 210 extending from the back side of the coupling ring 220. The filter bag 210 would extend into a hose, such as hose 132 of FIG. 1.

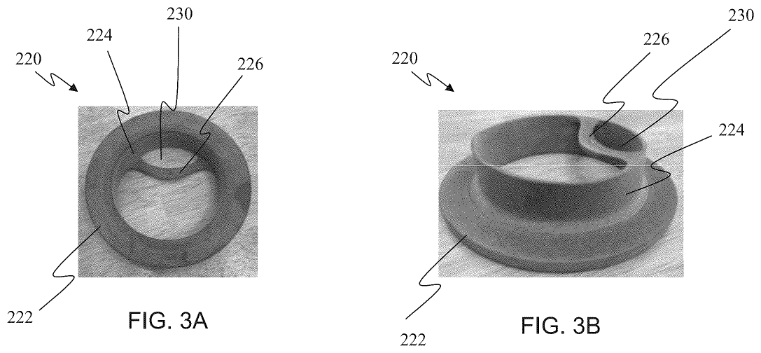

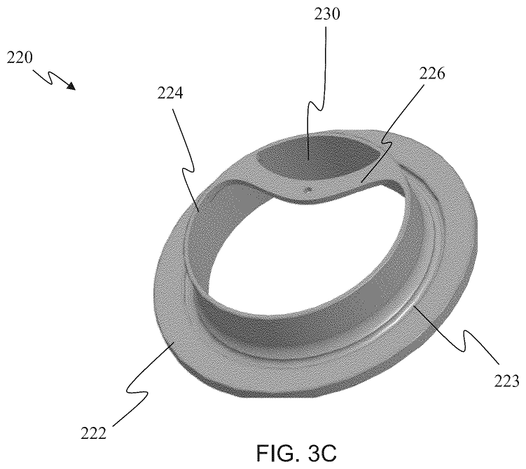

FIG. 2C shows a side view of the IFD filter 200 where the filter bag 210 is connected to the coupling ring 220. For the IFD filter 200, the filter bag 210 is permanently connected to the coupling ring 220 via stitching 230. In FIG. 2C, additional stitching 240 is shown that is used to form the filter bag 210 using the filter material. FIG. 2D shows a top view of the IFD filter 200 as would be seen when the IFD filter 200 is positioned in the hose. Additional details of coupling ring 220 are provided in FIGS. 3A, 3B and 3C.

FIGS. 3A-3C illustrate different viewpoints and features of coupling ring 220 constructed according to the principles of the disclosure. Coupling ring 220 includes a circular seal portion 222, a flange 224, and a tab 226. FIG. 3A provides a top view of the coupling ring 220 that shows the top of the circular seal portion 222, an inner portion of the flange 224, and the tab 226 located within an inner diameter of the flange 224. The coupling ring 220 can be a single component that formed from a single substance, such as vie 3D printing, a mold, or extrusion.

The circular seal portion 222 provides a seal between a male and female camlock connection when the male adaptor and female coupler are connected together. As such, the circular seal portion 222 has a thickness that allows a sealed connection when the IFD filter is placed in a hose as shown in FIGS. 4 to 6. The circular seal portion 222 can sit on a circular protrusion of a female coupler of a hose as shown in FIG. 4. A width of the circular seal portion 222 extending from the flange can correspond to the width of the circular protrusion. The flange 224 provides an extended surface for attaching a filter bag onto the coupling ring 220. The attachment can be permanent or non-permanent. The tab 226 attaches to the end of the flange 224 opposite of the circular seal portion 222. An opening or gap between the tab 226 and the flange 224, denoted by element number 230 in FIGS. 3A to 3C, allows fuel flow while also providing a space to grab the tab 226 and remove from within a hose after delivery of the fuel, such as from hose 132.

FIG. 3B provides a side view of the coupling ring 220 showing the flange 224 extending from the circular seal portion 222. The overall size of the coupling ring 220 can be specifically scaled to fit various hose sizes, such as 2″, 4″, 5″, or 6″, and corresponding camlock connections. Considering a 4” hose and camlock female coupler, the circular seal portion 222 can have a thickness within a range of, for example, 5.25 mm to 5.8 mm, and an overall outer diameter of, for example, 122.8 mm to 123.4 mm. The flange 224 can extend from the circular seal portion 222 by, for example, 20 mm to 27 mm. A surface of the circular seal portion 222 extending from the flange 224 can have a width of, for example, 19.6 mm to 20 mm. On the underside of the circular seal portion 222 that extends from the flange 224, the circular seal portion 222 can include a groove. The underside of the circular seal portion 222 is the side that sits on the circular protrusion and the location and dimensions of the groove can correspond to the circular protrusion. The groove can be, for example, 2.5 mm deep and 4 mm in width. FIG. 3C illustrates the coupling ring 220 with groove 223.

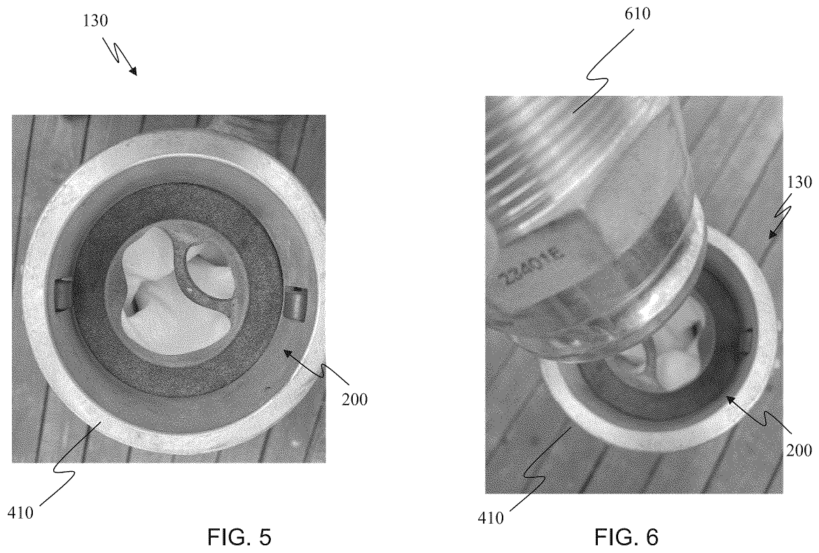

FIG. 4 shows a portion of fuel delivery system 130 with the IFD filter 200 being placed in female coupler 410 of fuel delivery hose 132. The circular seal portion 222 of the coupling ring 220 will sit on the circular protrusion 412 of the female coupler 410 of hose 132. FIG. 5 shows a top view of the fuel delivery system 130 after the IFD filter 200 is placed in the female coupler 410 of the fuel delivery hose 132. In FIG. 5, the circular seal portion 222 of the coupling ring 220 is sitting on the circular protrusion 412 (not visible in this figure). The hose 132 can be connected to a male adapter, such as on valve 112, to form a connection for delivery fuel through the IFD filter 200. FIG. 6 represents a connection between the female coupler 410 and a male adapter 610, such as integrated with valve 112 in FIG. 1. As disclosed herein, the fuel delivery system 130 can be used with delivering fuel to bulk fuel tanks. The fuel delivery system 130 can also be used for other applications when moving fuel, such as from one storage tank to another storage tank.

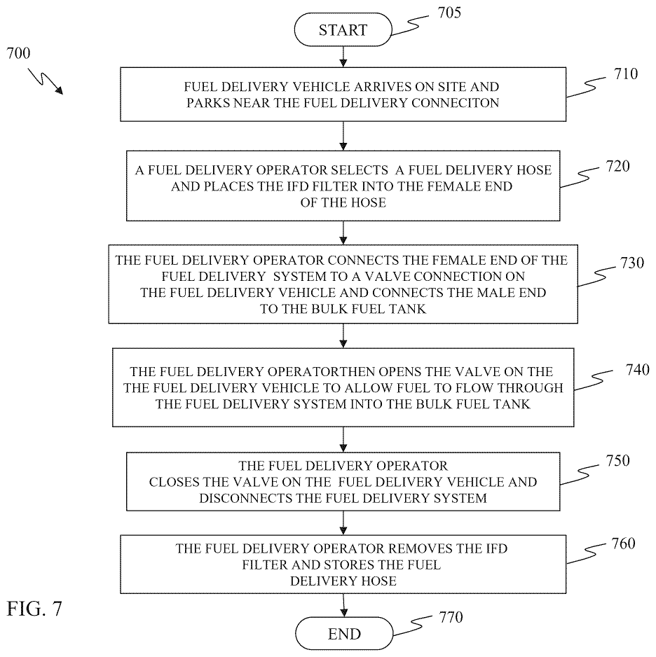

FIG. 7 illustrates a flow diagram of an example method 700 of delivering fuel carried out according to the principles of the disclosure. Method 700 is directed to providing fuel to a UST and FIG. 1 illustrates an example of a configuration for carrying out the method 700. As such, references to FIG. 1 are included below. A similar method can also be used to deliver fuel to an AST. Method 700 begins in step 705.

In step 710, a fuel delivery vehicle arrives on site and parks near a bulk fuel tank. The fuel delivery vehicle and the bulk fuel tank can be, for example, fuel delivery vehicle 110 and UST 120 of FIG. 1.

A fuel delivery operator selects a fuel delivery hose and places an IFD filter into the female end of the hose in step 720. The size of the fuel delivery hose selected can vary depending on, for example, the valve connections of the fuel delivery vehicle and the bulk fuel tank. The combination of the IFD filter and the hose is a fuel delivery system. Hose 132 provides an example of the hose and IFD filter 200 provides an example of the IFD filter. FIG. 4 illustrates an example of placing IFD filter 200 in the female coupler 410 of hose 132. The fuel delivery operator can be the driver of the fuel delivery vehicle.

In step 730, the fuel delivery operator connects the female end of the fuel delivery system to a valve connection on the fuel delivery vehicle and connects the male end to the bulk fuel tank. The valve includes a male adaptor configured to couple with the female coupler integrated with the hose. For example, the female end of the fuel delivery system 130 can be connected to valve 112 and the male end can be connected to valve 122 as shown in FIG. 1. FIG. 6 provides an example of female coupler 410 and the corresponding male adaptor 610.

The fuel delivery operator then opens the valve on the fuel delivery vehicle to allow fuel to flow through the fuel delivery system into the bulk fuel tank in step 740. The valve at the bulk fuel tank is also opened for delivering the fuel. For example, with respect to FIG. 1 the flow of fuel is gravity fed into the UST 120 when valves 112 and 122 are opened. For an AST, a pump would typically be used to deliver the fuel from the fuel delivery vehicle

When the desired amount of fuel has been delivered to the bulk fuel tank, the fuel delivery operator closes the valve on the fluid delivery vehicle in step 750 and disconnects the fuel delivery system. The valve at the bulk fluid tank is also closed allowing removal of the fluid delivery system. For example, valves 112 and 122 can be closed and the fuel delivery system 130 can then be disconnected. The desired amount of fuel can be the totality of fuel in the fuel tank of the fuel delivery vehicle or a lesser amount than the total.

In step 760, the fuel delivery operator removes the IFD filter and stores the fuel delivery hose. IFD filter 200 can be removed from hose 132, for example, by grasping tab 226 and pulling the IFD 200 out of the female coupler 410 of hose 132. Hose 132 can then be stored in a designated location of the fuel delivery vehicle 110, such as a hose rack. When the IFD has a permanently attached filter bag, the used IFD filter can be placed in a designated filter disposal, such as a filter trash can. If a non-permanent connection is used, the filter bag can be removed from the coupling ring and the filter bag can be disposed. The coupling ring can then be reused.

Method 700 continues to step 770 and ends.

The examples described herein were selected and described in order to best explain the principles of the disclosure and the practical application, and to enable others of ordinary skill in the art to understand the disclosure for various examples with various modifications as are suited to the particular use contemplated. The particular examples described herein are in no way intended to limit the scope of the present disclosure as it may be practiced in a variety of variations and environments without departing from the scope and intent of the disclosure. Thus, the present disclosure is not intended to be limited to the embodiment shown, but is to be accorded the widest scope consistent with the principles and features described herein.

The terminology used herein is for the purpose of describing particular examples only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Configured or configured to means, for example, designed, constructed, or fabricated with the necessary features or components for performing a task or tasks.

Those skilled in the art to which this application relates will appreciate that other and further additions, deletions, substitutions and modifications may be made to the described examples. Each of the below independent claims may have one or more of the additional features of the dependent claims in combination.

What is claimed is:

1. An in-line fuel delivery (IFD) filter for use with a fuel delivery hose having a female portion of a connector at one end, comprising:
a filter bag; and
a coupling ring connected to the filter bag, wherein the filter bag is affixed to the coupling ring and the coupling ring is configured to rest on a circular protrusion of the female portion of the connector.

2. The IFD as recited in claim 1, wherein the coupling ring includes a flange and the filter bag is affixed to the coupling ring via the flange.

3. The IFD as recited in claim 1, wherein the filter bag is affixed to the coupling ring via a mechanical or a chemical connection.
The IFD as recited in claim 1, wherein the filter bag is permanently affixed to the coupling ring.

5. The IFD as recited in claim 1, wherein the coupling ring includes a circular seal portion that forms a seal between the female portion of the connector and a male portion of the connector when the female portion and the male portion are securely connected.

6. The IFD as recited in claim 5, wherein the connector is a camlock connector and the female portion is a female coupler integrated with the fuel delivery hose and the male portion is a male adaptor integrated with a valve.

7. The IFD as recited in claim 6, wherein the circular seal portion includes a groove that corresponds to the circular protrusion.

8. The IFD as recited in claim 1, wherein the coupling ring includes a tab for removal of the IFD from within the fuel delivery hose.

9. The IFD as recited in claim 8, wherein the tab is located within a circumference of a flange of the coupling ring.

10. The IFD as recited in claim 1, wherein the coupling ring is a single component.

11. The IFD as recited in claim 1, wherein the coupling ring is a single component that includes a circular seal portion, a flange, and a tab, wherein the filter bag is permanently attached to the flange, wherein the connector is a camlock connector and the female portion is a female coupler integrated with the fuel delivery hose and the circular seal portion forms a seal between the female coupler and a male adaptor when the female coupler and the male adaptor are securely connected.

12. The IFD as recited in claim 11, wherein the circular seal portion includes a groove that corresponds to the circular protrusion.

13. The IFD as recited in claim 12, wherein the filter bag and the coupling ring are constructed of fuel tolerant materials.

14. A fuel delivery system, comprising:
a fuel delivery hose; and
an in-line fuel delivery (IFD) filter located within a female camlock coupler of the fuel delivery hose, wherein the IFD filter includes:
a filter bag; and
a coupling ring connected to the filter bag, wherein the filter bag is affixed to the coupling ring and the coupling ring is configured to rest on a circular protrusion of the female camlock coupler.

15. The fuel delivery system as recited in claim 14, wherein the coupling ring includes a flange and the filter bag is permanently affixed to the coupling ring via the flange.

16. The fuel delivery system as recited in claim 15, wherein the coupling ring includes a circular seal portion that forms a seal between the female camlock coupler and a male camlock adaptor when the female camlock coupler and the male camlock adaptor are securely connected.

17. The fuel delivery system as recited in claim 16, wherein the circular seal portion includes a groove that corresponds to the circular protrusion.

18. The fuel delivery system as recited in claim 17, wherein the coupling ring includes a tab located within a circumference of a flange of the coupling ring.

19. A method of delivering fuel to a bulk fuel tank, comprising:
placing an in-line fuel delivery (IFD) filter into a female camlock coupler of a fuel delivery hose, wherein the IFD filter includes:
a filter bag; and
a coupling ring connected to the filter bag, wherein the filter bag is affixed to the coupling ring and the coupling ring is configured to rest on a circular protrusion of the female camlock coupler; and
connecting the female camlock coupler to a male camlock adaptor integrated with a valve of a fluid delivery vehicle.

20. The method as recited in claim 19, wherein the bulk fuel tank is an underground storage tank and the method further includes connecting fuel delivery hose to the underground storage tank.
